(19) United States
(12) Patent Application Publication
(10) Pub. No.: US 2012/0202715 A1
(43) Pub. Date: Aug. 9, 2012

(54) TISSUE DISSAGGREGATOR DEVICE AND METHODS OF USING THE SAME

(76) Inventors: Santiago Partida-Sanchez, Hilliard, OH (US); Paul Thom, Butler, NJ (US); Robert N. Petersen, Somerset, NJ (US); Francis Gomes, Lincoln Park, NJ (US)

(21) Appl. No.: 13/368,509

(22) Filed: Feb. 8, 2012

Related U.S. Application Data
(60) Provisional application No. 61/440,971, filed on Feb. 9, 2011.

(51) Int. Cl. C40B 50/00; B01L 3/00

(52) U.S. Cl. 506/23; 422/552

(57) ABSTRACT

The tissue disaggregator device includes a base having a multiple well array. Each of the wells includes a screen embedded into bottom portion of the well. The device removably connects with standardized plate and allows for multiple fold increase in tissue sample preparation.

### CROSS REFERENCE TO RELATED APPLICATIONS

The present application claims the benefit of U.S. Patent Application No. 61/440,971 titled “Tissue Disaggregator”, filed on Feb. 9, 2011, which is hereby incorporated by reference herein in its entirety.

### FIELD OF THE INVENTION

The present invention relates generally to disaggregation of tissue cells, and more particularly, to a tissue disaggregator device commonly used for processing of tissue cells in a variety of protocols for diverse purposes in a laboratory environment.

### BACKGROUND OF THE INVENTION

Conventional tissue dissociation sieves include a single filter or screen with a meshed or perforated bottom used for separating cells from tissue pieces. Some examples of the typical tissue dissociation sieves products are disclosed by Sigma: Cell Dissociation Sieve-Tissue Grinder Kit and BD Falcon Cell Strainers. However, these screens are single cup designs that allows only for any processing of the tissues one at a time which can be both time consuming and costly. Also, many of cells obtained from these single cup screens do not provide for good results when tested for cell viability.

Therefore, there is a need in the art to provide for a tissue separator that is configured to include a multiple array of screens to be able to process multiple tissue samples at the same time. There is also a need in the art to accurately match the multiple arrays of screens with an industry standard plate. This results in decrease of the processing time of the tissues and an increase in cell viability.

### SUMMARY OF THE INVENTION

The above-described problems are addressed and a technical solution is achieved in the art by a tissue disaggregator device. The tissue disaggregator device includes a base having a multiple well array each of the wells having a bottom portion.

In one embodiment, the bottom portion of the wells of the tissue disaggregator device includes a screen embedded into the wells.

In another embodiment, the tissue disaggregator device is made of preferably clear plastic material and is chemical-resistant and autoclave-safe.

In another embodiment, the tissue disaggregator device is removably mated with industry standardized collection plates.

In a further embodiment there is provided a method for using the tissue disaggregator device. The method includes pouring a liquid solution into multiple wells of a base such that each of the wells comprises a bottom portion having a screen configured to allow for flow through of a liquid solution. The base is removably mated with a standard collection plate having an array of multiple plate wells. The method also includes depositing a tissue directly atop of screen but below surface of liquid solution in the multiple wells of the base in order for the tissue to remain viable in the liquid solution.

### BRIEF DESCRIPTION OF THE DRAWINGS

The present invention will be more readily understood from the detailed description of exemplary embodiments presented below considered in conjunction with the attached drawings, of which:

FIG. 1 is an exemplary view of a tissue disaggregator device in accordance with an embodiment of the present invention;

FIG. 1A illustrates a cross-sectional view of the device of FIG. 1 in accordance with an embodiment of the present invention.

FIG. 2A illustrates an exemplary view of a industry standardized plate and the device of FIG. 1 in accordance with another embodiment of the present invention;

FIG. 2B illustrates a cross-sectional view of the industry standardized plate of FIG. 2A in accordance with an embodiment of the present invention

FIG. 2C illustrates an exemplary view of the device of FIG. 1 connected with the industry standardized plate of FIG. 2A in accordance with another embodiment of the present invention;

FIG. 2D illustrates an exemplary view of the device of FIG. 1 separated from the industry standardized plate of FIG. 2A in accordance with another embodiment of the present invention;

FIG. 2E is a cross-sectional view of FIG. 2C illustrating the device in relation to the standardized plate in accordance with another embodiment of the present invention;

FIG. 3 discloses an exemplary view of the use of the device illustrated with respect to the cross-sectional view of FIG. 2E in accordance with an embodiment of the present invention.

FIG. 3A illustrates an exemplary use of the device in view of FIG. 3 in accordance with one embodiment of the present invention.

FIG. 3B illustrates an exemplary use of the device in view of FIG. 3 in accordance with another embodiment of the present invention.

FIG. 3C illustrates an exemplary use of the device in view of FIG. 3 in accordance with a further embodiment of the present invention.

### DETAILED DESCRIPTION OF THE INVENTION

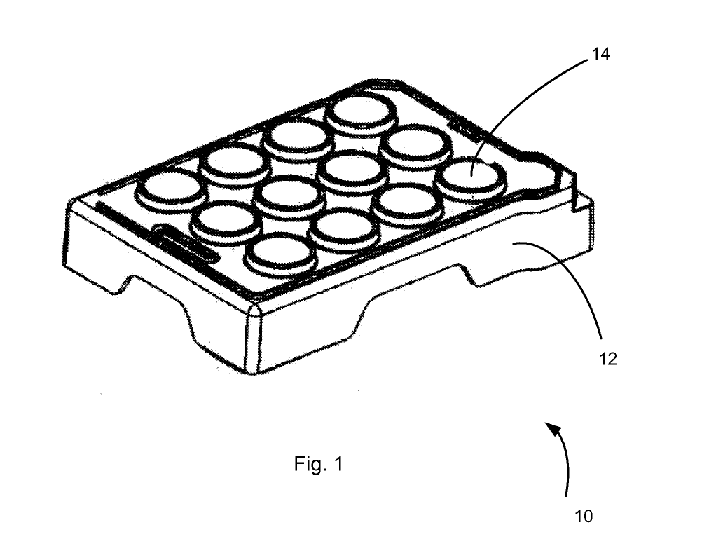

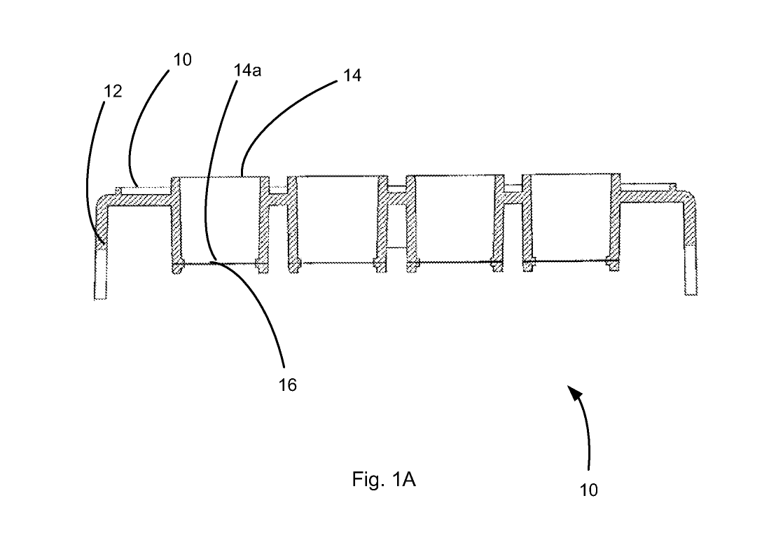

FIG. 1 shows a tissue disaggregator device 10 having a base 12. The base 12 includes a substantially flat bottom portion and a top portion having an array of multiple wells 14. Even though the tissue disaggregator device, a.k.a. device 10 as shown in the embodiment of FIG. 1 includes twelve wells 14, one of ordinary skill in the art can appreciate that device may include any number of wells except a single well. Also, the device 10 as illustrated in this embodiment includes a 3×4 array of wells, but one of ordinary skill in the art can appreciate that device may include other numbers of array. The device 10 of the present invention is constructed preferably of a plastic material that is crystal-clear allowing visibility of the cells. In one embodiment, the device 10 is preferably chemical-resistant in order to be disinfected with alcohol and similar sanitizers. In another embodiment, the device 10 is sterilized preferably for the purpose of tissue culture by subjecting it to high pressure, saturated steam at 121° C. or more, typically for 15-20 minutes using any suitable autoclave equipment. Thus, the device 10 is autoclave safe for sterility, which may be needed if obtained cells are going to be used in cell culture experiments.

FIG. 1A illustrates a cross-sectional view of the device of FIG. 1 in accordance with an embodiment of the present invention. In one embodiment, each of the wells 14 of the device 10 have a bottom portion 14a which include screens 16 placed at the bottom portion 14 a of the well 14. In one embodiment, the screens 16 are removable from the bottom portion 14 of the well 14. In another embodiment, the screens 16 are permanently embedded into the bottom portion 14a of the well 14. The screen 16 is made of materials such as steel, mesh, nylon, rubber plastic or other suitable materials. In one embodiment, the screens 16 are preferably made of 316 grade stainless steel with approximately 70 microns of wire mesh. In another embodiment, the screen 16 has a size range from approximately 19 mm to 6 mm in diameter and a mesh count of 60 to 80.

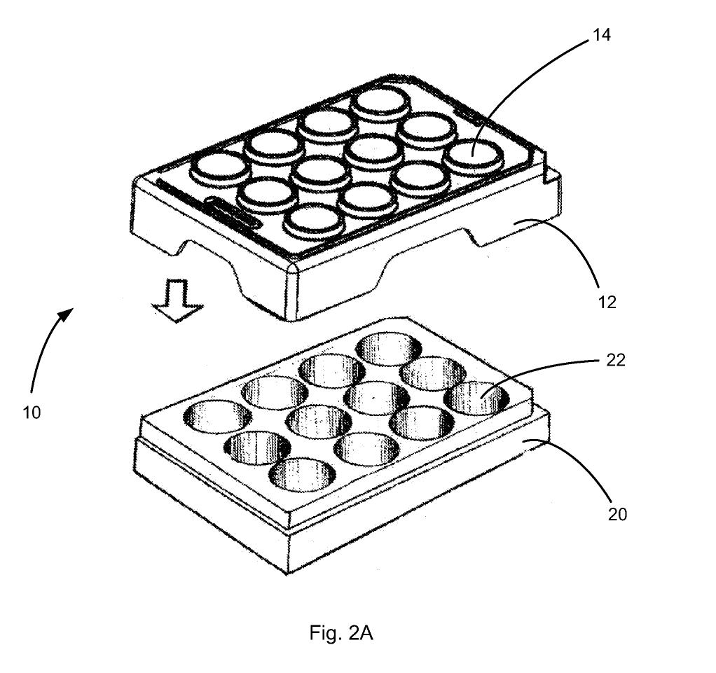

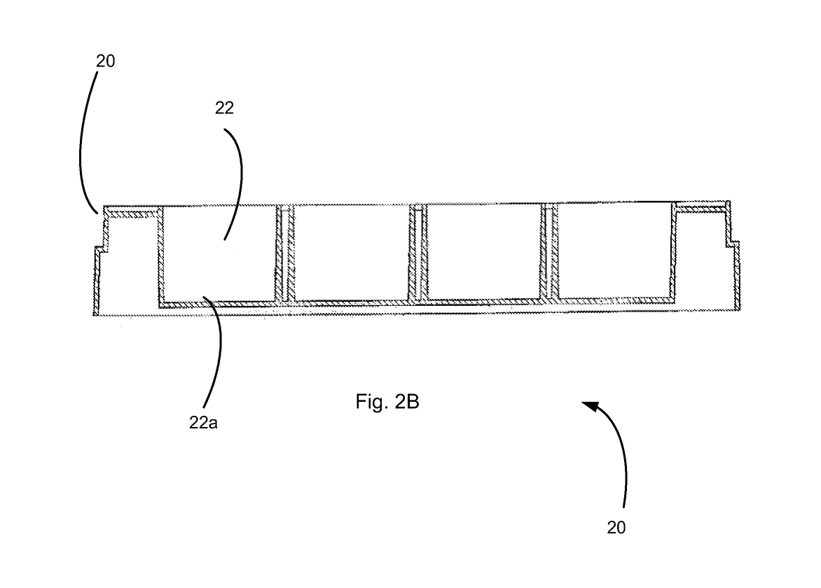

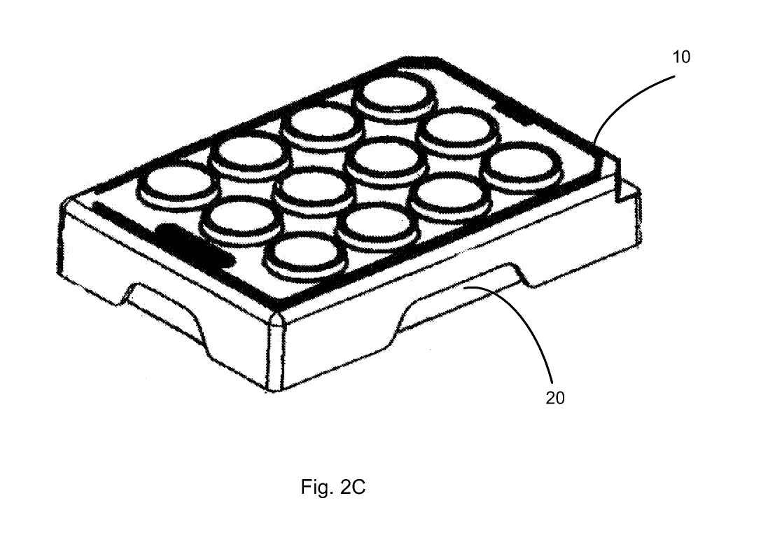

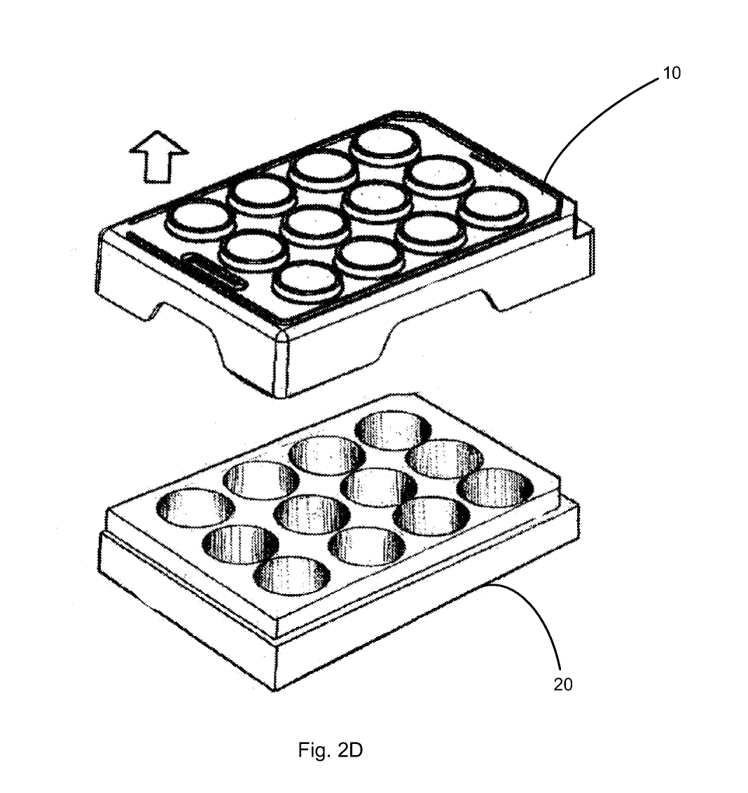

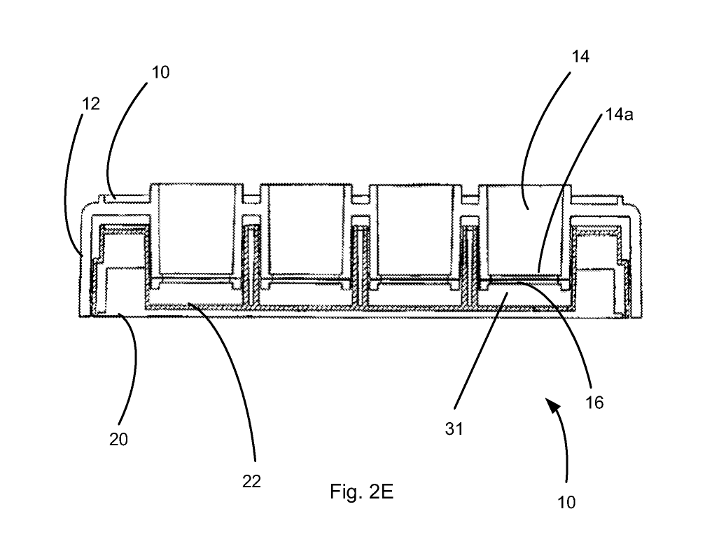

FIG. 2A illustrates an exemplary view of an industry standardized plate 20 in accordance with an embodiment of the present invention. The industry standardized plate, a.k.a. plate 20 of FIG. 2A includes plate wells 22 and is also known as a collection plate configured to collect the tissue cells from the device 10. It is noted that the plate 20 preferably includes twelve plate wells 22 and a 3×4 array of cells to match with the device 10 as shown. Thus, one of ordinary skill in the art can appreciate that the plate 20 will preferably include the same number of collection wells and the same number of array of wells as the device 10 in order to collect the tissue samples. Further, one of ordinary skill in the art can appreciate that device 10 is designed around the footprint of the plate 20 in order to connect with the device 10 such that the plate 20 is easily removable from the device 10. The device 10 is designed to connect with the plate 20 so each of the wells 14 of the device 10 mates perfectly with the plate wells 22 in order to allow for multiple-fold (12-fold in the example of FIG. 2A) design. This results in an increase in sample preparation compared to single cup designs of the prior art. The arrow shown in FIG. 2A simply illustrates moving the device 10 downward in the arrow direction as shown in order to place the device 10 on the plate 20.

FIG. 2B illustrates a cross-sectional view of the industry standardized plate 20 of FIG. 2A in accordance with an embodiment of the present invention. In one embodiment, each of the plate wells 22 of the plate 20 have a bottom portion 22a configured to receive the tissue cells from the bottom portion 14a of the wells 14 of the device 10.

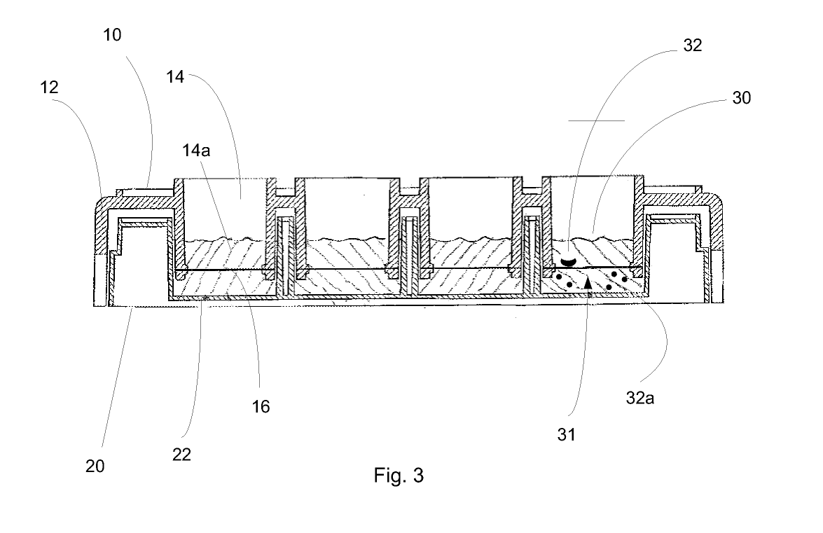

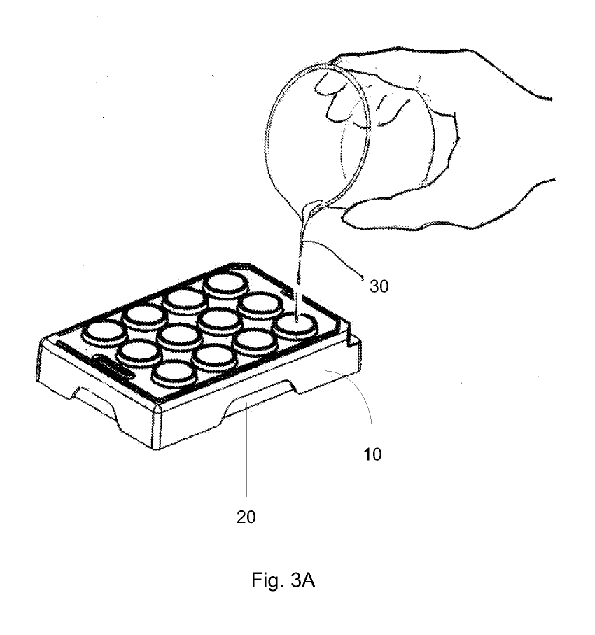

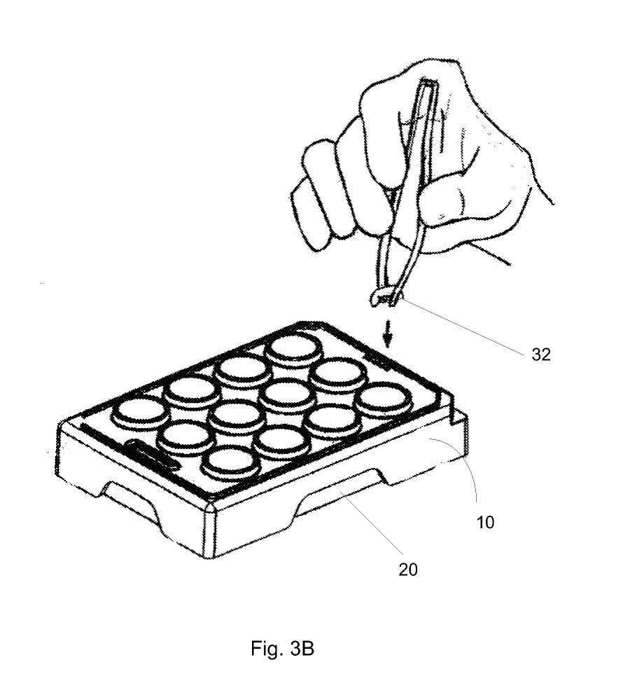

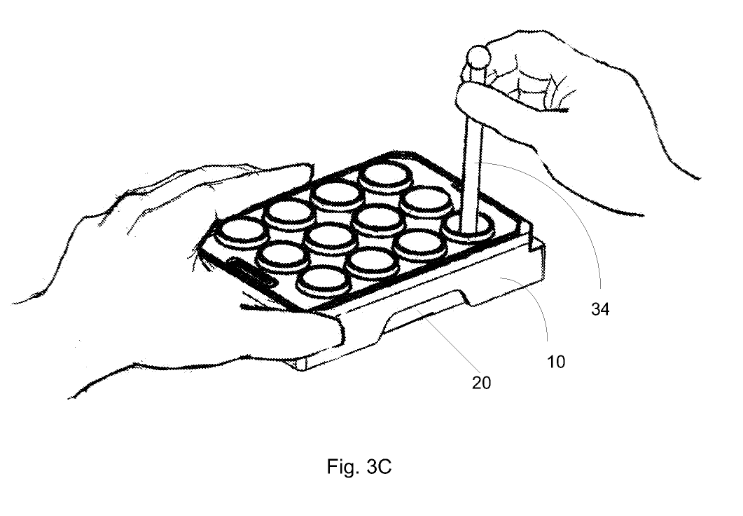

FIG. 2C illustrates an exemplary view of the device 10 of FIG. 1 nested on the plate 20 of FIG. 2A. As discussed above, the device 10 is designed around the footprint of the plate 20 so that the device 10 will fit atop and nest with the plate 20 in such a way that there is very minimal gap between side walls of the device 10 and the plate 20. The device 10 will connect with the plate 20 in such a way that there is an area or gap formed between the screen 16 of the device 10 and the bottom 22a of the well 22 of the plate details of which will be provided with respect to FIG. 3 below. The tissues (not shown) are placed on top of screen 16 until they are mechanically forced through the screen by use of a pestle or other suitable device as will be described in greater detail with respect to FIG. 3B and FIG. 3C below.

FIG. 2D illustrates an exemplary view of the device 10 easily separated from the plate 20 by removing the device 10 upward in the arrow direction as shown.

FIG. 2E is a cross-sectional view of FIG. 2C illustrating wells 14 of the device 14 in relation to the plate wells 22 of the plate 20 in accordance with another embodiment of the present invention. As discussed above, there is very minimal gap between the side walls of the device 10 and the plate 20. The device 10 connects with the plate 20 in such a way that there is an area or gap 31 formed between the screen 16 of the device 10 and the bottom 22a of the well 22 of the plate 20.

FIG. 3 discloses an exemplary view of the use of the device 10 illustrated with respect to the cross-sectional view of FIG. 2E which will be described in greater detail herein below with respect to FIGS. 3A, 3B and 3C.

FIG. 3A discloses an exemplary view of the use of the device 10 in view of FIG. 3 in accordance with one embodiment of the present invention. In this embodiment, a liquid solution 30 is illustrated as being poured into the wells 14 of the device 10. Some examples of the liquid solution include but not limited to, isotonic, phosphate buffered saline (PBS) etc. As shown in FIG. 3, some of the liquid solution 30 flows freely in well 14 and rest of the liquid solution 30 flows from the bottom portion 14a into the screen 16 and eventually into the bottom portion 22a of the plate well 22 as shown in FIG. 3. Liquid isotonic buffer is used preferably as the liquid solution 30 for the purpose of washing and carrying the cells from the disaggregated tissues into the wells 22 of the plate 20 which will ultimately contain the cell suspension.

FIG. 3B discloses an exemplary view of the use of the device 10 in view of FIG. 3 in accordance with another embodiment of the present invention. In this embodiment, a tissue 32 is being deposited directly into the wells 14 of the device 10. As shown in FIG. 3, the tissue 32 is deposited into the screen 16 of the bottom portion 14a of the well 14 which maintains tissues in the isotonic buffer solution. In one embodiment, the tissue 32 rests on top of the screen 16 and remains in a preserved state due to the liquid solution 30 as shown in FIG. 3. As known to one skilled in the art, time required collecting multiple tissue samples from single or multiple source(s) can vary from a few seconds to tens of minutes. As such, during extended sample gathering time frames, there is little or no concern for tissue viability as the tissues can be collected and individually deposited into a single well and remain suspended in the isotonic buffer solution while waiting to be processed. Furthermore, testing of the device 10 resulted in several advantages. One such advantage is decrease of tissue cell processing time compared to the current methods. The device 10 mates with the standard industrialized plate 20 which enables sequential processing of twelve distinct tissue samples directly into culture plate wells without the need for transfer or washing multiple times a single cup device. Thus the processing of twelve tissue spleen samples takes approximately 5-7 minutes compared to the processing time of 25-35 minutes using other single sample devices. Another advantage is a significant increase in cell viability, as the cells are maintained immersed in physiological buffer at all times. During testing, spleen cell viability was observed as being equal to or greater than approximately 95% in each of 12 samples processed using the disaggregator device 10 with twelve wells as compared to cell viability to be equal to less than 80% in each of twelve spleen samples after processed with a single cup unit device. The measurement of cell viability is preferably performed by trypan blue dye exclusion test, where live cells are impermeable to the blue dye and can be counted by microscopy. In another embodiment, the device 10 with the liquid solution 30 such as an isotonic buffer solution and tissues 32 may preferably be placed in an environment having a temperature in the range of 0 degrees C. to 4 degrees C. as a further means of maintaining tissue viability during the sample collection period.

FIG. 3C discloses an exemplary view of the use of the device 10 in view of FIG. 3 in accordance with another embodiment of the present invention. In this embodiment, a pestle 34 is inserted into the well 14 as shown. A researcher uses the pestle 34 to apply force to the tissue 32 by preferably pressing the tissue 32 through the screen 16 thereby disrupting the organ structure and producing separate tissue cells 32 from the tissue 32 which are contained in the liquid solution 30. As illustrated in FIG. 3, the force by the pestle 34 pushes the tissue 32 through the screen 16 to produce cells which are collected in the area 31 between the screen 16 of the device 14 and the bottom 22a of the plate well 22 of the plate 20. As such, the action of passing the tissue 32 through the screens 16 disaggregates the tissue structure to produce the desired cell isolates. Even though pestle 34 is shown, one skilled in the art can appreciate that any other suitable device can be used to perform the same function as the pestle. Additionally, mechanical grinding may preferably generate cell suspensions from tissues that are much harder when such tissues are subject to pre treatment with enzymes to soften up (digest) the organs before disaggregation.

The device 10 of the present invention provides some additional advantages. One such additional advantage is that the small area of the screen 16 at the bottom portion 14a of the well 14 reduces the volume of the liquid solution 30 to be used and allows for higher concentration of the cell suspension. Also, the one piece assembly of borderless and integral material of the screen 16 prevents tissues from getting trapped in a gap thereby increasing cell yields during either of the pressing or the mechanical grinding of the tissue.

The tissue disaggregator device described in the present invention is used in many applications. Many such applications include but are not limited to flow cytometry, cell isolation for cell culture work, cell counting, cell sorting, immunology and many more.

It is to be understood that the exemplary embodiments presented herein are merely illustrative of the invention and that many variations of the above-described embodiments may be devised by one skilled in the art without departing from the scope of the invention.

1. A tissue disaggregator device comprising:
a base having an array of multiple wells, wherein each of said wells comprises a bottom portion having at least one screen.

2. The device of claim 1 wherein the base comprise a plastic material.

3. The device of claim 1 wherein the base comprise a transparent material.

4. The device of claim 1 wherein the base comprise a chemical resistant material.

5. The device of claim 1 wherein the base comprise an autoclave safe material.

6. The device of claim 1 wherein the screen comprise one of steel, mesh, nylon, plastic and rubber material.

7. The device of claim 6 wherein the screen is embedded into the bottom portion of the well.

8. The device of claim 1 wherein the base is configured to removably mate with a plate having an array of multiple plate wells.

9. The device of claim 1 wherein a gap is formed between the screen and the plate well upon the mate.

10. The device of claim 9 wherein a liquid solution is placed in the well prior to receipt of a tissue.

11. The device of claim 10 wherein the liquid solution floats in the well and is configured to flow from the screen into the gap and the plate well.

12. The device of claim 11 wherein the mate allows for tissue cells to flow from the screen to be collected in the gap.

13. A method comprising:
providing a tissue disaggregator device having a base with an array of multiple wells, wherein said base is removably mated with a plate having an array of multiple plate wells;
pouring a liquid solution into multiple wells of the base, wherein each of said multiple wells comprise a bottom portion having at least one screen to allow for floating of a liquid solution; and
depositing at least one tissue directly onto the screen, wherein the tissue remains viable in the liquid solution.

14. The method of claim 13 further comprising applying a force onto the tissue to force tissue through the screen thereby disaggregating the tissue structure to produce cells in suspension.

15. The method of claim 14 wherein the applied force pushes the cells into an area between the screen and the plate well of the plate.
